(19) United States
(12) Patent Application Publication
(10) Pub. No.: US 2006/0251313 A1
(43) Pub. Date: Nov. 9, 2006

(54) Method of producing a cross-sectional image

(76) Inventors: Marc Liévin, Bonn (DE); Erwin Keeve, Bonn (DE)

Correspondence Address: Dykema Gossett PLLC;Suite 300 West, 1300 I Street, N.W., Washington, DC, 20005-3306, US

(21) Appl. No.: 11/482,018

(22) Filed: Jul. 7, 2006

Related U.S. Application Data
(63) Continuation of application No. PCT/EP05/00019, filed on Jan. 4, 2005.

(30) Foreign Application Priority Data
Jan. 8, 2004 (DE) 10 2004 001 273.3

(51) Int. Cl. G06K 9/00

(52) U.S. Cl. 382/131

(57) ABSTRACT

The invention relates to a method for producing a sectional image of an object consisting of artifacts, wherein two-dimensional image data is, for example, produced with the aid of a computer tomograph. Two-dimensional image data is produced from various projection devices. According to the invention, pixels, which have a disruptive data value caused by the artifact, are detected. The thus defected pixels are combined to form image areas. In a next step, the image areas are filled by means of filling methods and corrected image data is thus produced. The cross-sectional image of the object is produced on the basis of the corrected image data by retroprojection, for example.

The invention relates to a method of producing a cross-sectional image of an object comprising one or more artifacts. In particular, the invention relates to the implementation of this method in medical fields.

For example, cross-sectional images of an object, usually parts of a human body, can be produced by means of computerized tomography. To this end, a number of X-ray examinations are carried out from different angles. For example, an X-ray beam source is caused to rotate around a human head. To this end, for example, a conical beam emitter is use which produces a conical beam, particularly an X-ray beam, which is rotated about the object to be examined. A cross-sectional image, ie a computed tomography image of a plane, is produced by so-called back projection of the resulting data. Methods of back projection are described, for example, in F. Natterer, “The Mathematics of Computerized Tomography”, New York: Wiley, 1986 and in W. Kalender et al., “Reduction of CT Artifacts Caused by Metallic Implants”, Radiology, Vol. 164, No. 2, August 1987, pp. 576-577.

If the region of which a computed tomography image is to be produced includes a sub-region of relatively high density compared with the normal tissue, the bone or teeth, the X-rays or other suitable investigative rays in such regions are attenuated to a greater extent than in the surrounding comparatively soft regions, such as the bone, the teeth, etc. The denser regions can be, for example, dental fillings of metal in the prostheses or parts thereof. The denser regions referred to as artifacts may also be, for example, metal screws or metal plates which have been used, for example, in operations on broken bones. Due to the strong attenuation of the radiation caused by such artifacts gaps are formed in the image projection. Furthermore artifacts cause stripes to appear in the image projection. Within these stripes a large amount of information is lost. The image quality in the region of the artifacts and in particular of the stripes formed is so poor that it is no longer possible to draw accurate medical conclusions therefrom. For example, bone segmentations using classical methods, such as thresholding methods, are no longer possible or lead to unreliable results (Otsu, N., “A thresholding selection method from graylevel histogram”, IEEE Transactions on Systems, Man, and Cybernetics, 9(1): 62-66, 1979).

The problem of the occurrence of stripes in cross-sectional images also occurs at saturation. In this case saturation occurs when the X-rays are not attenuated. Unlike metallic artifacts, which absorb the radiation and produce a white region in the projection, saturation causes black regions to appear in the projection. In both cases the regions are image areas disrupted by artifacts and capable of being processed using the same image processing programs.

For the reconstruction of three-dimensional objects or the production of cross-sectional images from two-dimensional, projected images various methods implementing a conical ray are known. Such a process is described in “Practical cone-beam algorithm” by L. A. Feldkamp, et. al.—J. Opt. Soc. Am. A/Vol. 1, No. 6 (June 1984). The process is based on a filtered back projection produced by two-dimensional image data, in which all projected images are first filtered and then back projected. The back-projected images are then combined to form a three-dimensional image, ie a cross-sectional image.

It is known to improve the image quality by removing the metal fillings from the images or the raw data manually. However, this process is extremely elaborate and unreliable.

Another method of improving the image data is filtered back projection, as is implemented in conventional computer tomography scanners. In this case the raw data are filtered with the aid of an algorithm in a suitable filter and the filtered data then back projected from the frequency domain to the 2D image domain. However, this process is limited by the number of projection angles. Such a process is described, for example, in F. Natterer, “The Mathematics of Computerized Tomography”, New York: Wiley, 1986.

Another known process for the reduction of artifacts in computer-aided tomography is described in G. Wang et al., “Iterative Deblurring for CT Metal Artifact Reduction”, IEEE Transactions on Medical Imaging, Vol. 15, No. 5, October 1995, pp. 657-664. This method is based on an estimation of a filtered back-projection formula for the reduction of unsharpness. Each step of the algorithm maximizes the estimator leading to the next value. In this method the necessary number of steps is carried out in order to reach a convergence criterion. Once the convergence criterion has been reached, the reconstruction is carried out. On account of the large number of necessary iterative steps, this method is very slow, but it produces relatively good results.

Another process for the reduction of artifacts is described in W. Kalender et al., “Reduction of CT Artifacts Caused by Metallic Implants”, Radiology, Vol. 164, No. 2, August 1987, pp. 576-577. In this case filtered back projection is used, and the metal objects are manually detected in the image produced and are back-projected. These projections are then linearly interpolated with the image data located in the environment of the artifacts. In the next step, the filtered data are back-projected onto the image.

It is an object of the invention to provide a method for the production of a cross-sectional image, which method reduces unwanted effects caused by artifacts.

According to the invention, the object is achieved by the features of claim 1.

In the method of the present invention, the two-dimensional image data produced are subjected to preprocessing, after which a cross-sectional image of the object is produced from the corrected image data. To this end, a first step of the method of the invention comprises the acquisition of two-dimensional image data of the object from different directions of projection. For example, the object, such as a part of the human body, is illuminated by X-ray radiation from several directions. To this end, a conical beam is preferably used, and it is particularly preferred to move the radiation source along a scanning path. This can be, for example, an elliptical movement, a circular movement or a portion of such movements.

The image data produced, which correspond to two-dimensional images but need not necessarily be combined to form such an image, according to the invention, are temporarily stored or processed directly. The image data are processed and individual pixels are detected which show an undesirable data value caused by the artifact. This can be an image of the artifact, ie of the foreign body itself. If the artifact is, for example, a metallic enclosure, such as a dental filling or a screw in a bone, this region will have a high density which casts, as it were, a shadow on the projected image, ie on the pixels, which therefore receive little or no radiation.

The undesirable data values can, however, include regions caused by saturation. Such regions can likewise be processed in the method of the invention so as to improve the image quality.

In the next step the unwanted pixels thus detected are grouped to form an image zone. According to the invention, this is carried out, in particular, separately for each individual two-dimensional projection from a different direction. The image zones thus determined, for example, the artifact depicted two-dimensionally, are corrected by filling operations so that corrected image data are produced. To this end, the image data present in the composite image zones are preferably temporarily stored for subsequent use if required. The filling operations assign the individual pixels with image data similar to the image data surrounding the image zone. Various filling methods are suitable for this purpose, such as are described in: “Grey Scale Image Morphological Operations” in Digital Image Processing, by W. K. Pratt, Second Edition, ISBN 0-471-85766-1, pp. 484-490; “Image Inpainting” by M. Bertalmio et al., Proceedings of SIGGRAPH 2000, New Orleans, US-A (July 2000) and “Filling in by Joint Interpolation of Vector Fields and Gray Levels”, C. Ballester et. al. IEEE Transactions on Image Processing (August 2001).

The corrected image data thus produced are then processed to produce the desired cross-sectional image of the object. In this case it is, for example, a computed tomography cross-sectional image. Preferably the cross-sectional image of the object is produced by back projection of the resulting individual corrected two-dimensional image data. Such a method of back projection is described, for example, in F. Natterer, “The mathematics of computerized tomography”, New York: Wiley, 1986.

The cross-sectional image of the object can alternatively be a preferably directly produced three-dimensional data set derived from the projections.

The unwanted data value can be defined by a critical value, a pixel being registered as “having an undesirable data value” when the data value exceeds or falls short of, said critical value. Likewise, a limiting range can be defined such that a pixel will be registered as “having an undesirable data value” when its data value falls within specified limits.

There are a large number of suitable two-dimensional image filling procedures which can be used as a filling operation for correcting the composite image zones. Special preference is given to image filling algorithms and/or morphological image closing procedures and/or image smoothing procedures. Image filling methods fill the composite image regions with values of adjacent image zones or pixels. Suitable image filling methods are described, for example, in “Image Inpainting”, M. Bertalmao et al., Proceedings of SIGGRAPH 2000, New Orleans, US-A (July 2000) and “Filling in by Joint Interpolation of Vector Fields and Gray Levels”, C. Ballester et al. IEEE Transactions on Image Processing (August 2001).

In a particularly preferred embodiment of the method of the invention, a cross-sectional image of the artifact is produced on the basis of the unwanted pixels. This is made possible by separately acquiring the pixels registered as unwanted in the two-dimensional projection and temporarily storing them. From these two-dimensional images there can then be made a cross-sectional image of the artifact in a manner similar to that used for producing a cross-sectional image of the object, preferably by back projection. The two cross-sectional images are then preferably combined. In this way it is possible to produce a cross-sectional image through, for example, a jaw or an operated bone etc., in which the artifact, such as a dental filling, a screw, or a metal plate, can be recognized in its exact position, since no undesirable stripes caused by the artifact can interfere with or block the determination of the position of the artifact. This is achieved in that the cross-sectional image of the object is produced on the basis of the corrected image data, that is to say, in particular, corrected two-dimensional images, and only then is the separately produced cross-sectional image of the artifact combined with the cross-sectional image of the object. Thus there is avoidance of stripes which would be caused by the artifact in the cross-sectional image produced by combining unprocessed two-dimensional image data.

Preferably, the production of the cross-sectional image of the object and/or of the cross-sectional image of the artifact is carried out by filtered back projection. Furthermore the cross-sectional image can be produced by the algebraic reconstruction technique (ART) or the maximum probability method (ML). These methods are described, for example, in “Multiscale Conebeam X-Ray Reconstruction” by Yves Trouset et. al., SPIE Vol. 1231 Medical Imaging IV: Image Formation ((1990).

In order to produce the two-dimensional image data, use is preferably made of a conical beam emitter, particularly one equipped with a C-shaped arm. It is also possible to create the two-dimensional image data by “digital volume tomography (DVT)”, by “spriral computer assisted tomography” and/or by “headical computer assisted tomography”. Instead of the use of X-rays use can be made of gamma cameras for position emission tomography (PET) or for single position emission computer tomography (SPECT).

The process of the invention is suitable, in particular, for medical applications. Such applications involve, for example, the analysis of, or operation on, teeth having dental fillings or the analysis of, or operation on, bone fractures or the like, in which screws, pins, plates etc. have been used.

The invention is explained in greater detail below with reference to a preferred embodiment and to the accompanying drawings, in which:

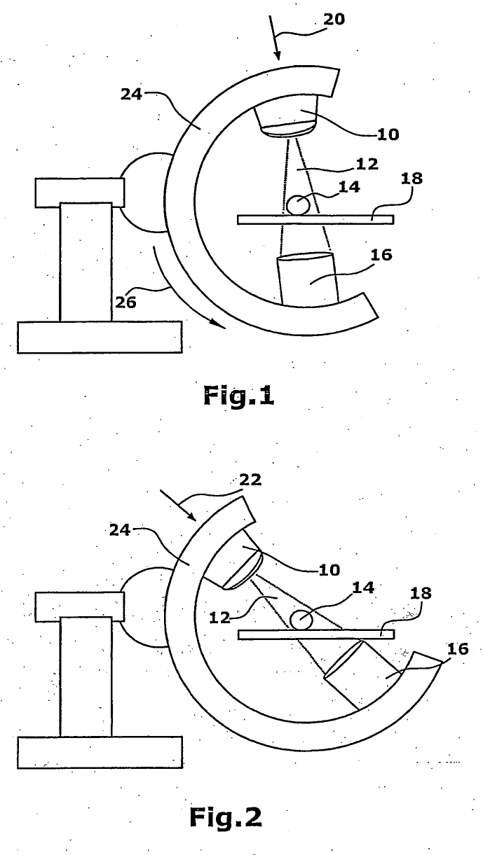

FIGS. 1 and 2 are each a diagrammatic view of a conical beam-generating computer tomographic apparatus having a C-shaped arm in different positions,

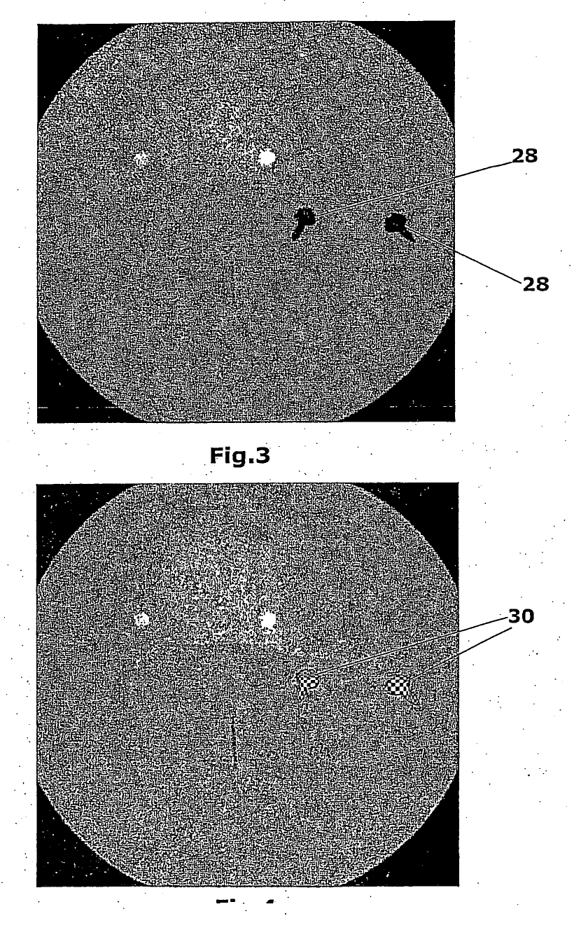

FIG. 3 shows a two-dimensional image produced by a computer tomograph as illustrated in FIGS. 1 and 2,

FIG. 4 shows the image illustrated in FIG. 3 in which the image zones containing unwanted pixels are additionally marked,

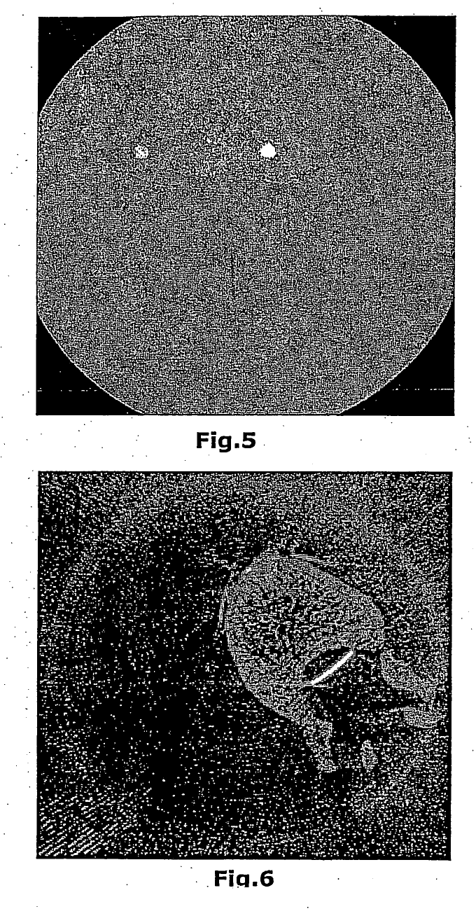

FIG. 5 shows the two-dimensional image illustrated in FIG. 4, in which image zones have been corrected by a filling operation,

FIG. 6 shows a cross-sectional image produced from several two-dimensional images corresponding to the image illustrated in FIG. 5,

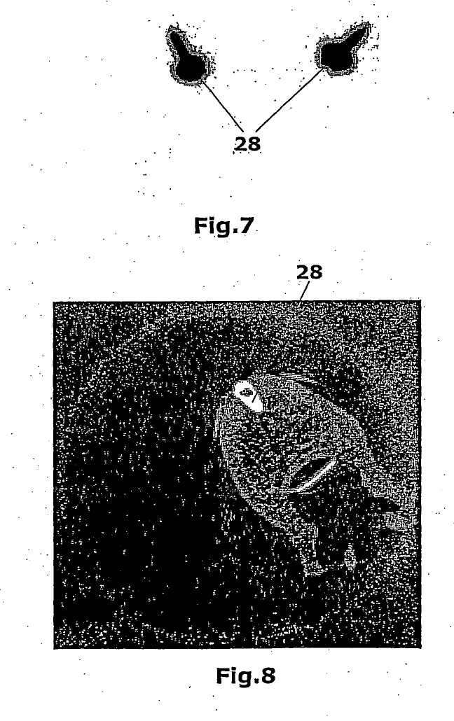

FIG. 7 shows a two-dimensional image of the artifacts removed from the image illustrated in FIG. 4,

FIG. 8 is a combination of a cross-sectional image of the artifact and the cross-sectional image of the object illustrated in FIG. 6, and

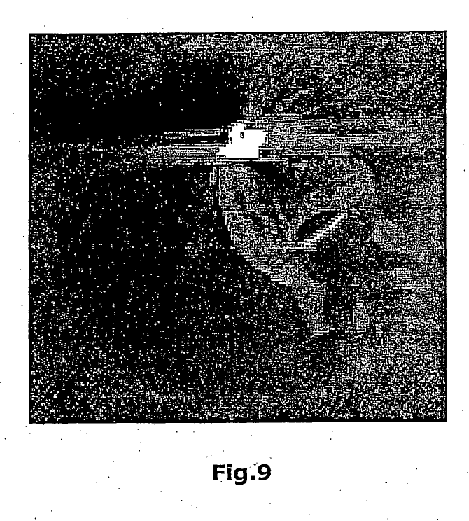

FIG. 9 shows a cross-sectional image corresponding to FIG. 8, to which the process of the invention has not been applied.

Cross-sectional images can be produced, for example, with computer tomographs. Such computer tomographs exhibit, for example, an X-ray beam source 10 which generates a conical beam 12. The conical beam 12 is directed toward an object 14, such as a human body. Two-dimensional image data are recorded by a detector 16 opposite the source of radiation 10. The object 14, such as a human body, is disposed on a table 18. For the creation of two-dimensional image data from different directions of projection 20, 22, a C-shaped arm 24 of the computer tomograph can be swiveled in the direction of an arrow 26 to the position illustrated in FIG. 2. For the production of a computed tomography cross-sectional image, up to 200 image frames are created from different directions of projection.

A single two-dimensional image of a human spine, as produced by computer tomography, is illustrated in FIG. 3. Thus in FIG. 3 the two-dimensional image data are visualized which are obtained by projection from one direction of projection. In this case two artifacts 28 in the form of screws are discernible in the projection. The artifacts 28 would, if a cross-sectional image were created from a large number of two-dimensional images taken from different directions of projection, form stripes in an image and make it impossible to determine the position of the screw and to provide information on the material surrounding the screw. Such a cross-sectional image is illustrated in FIG. 9.

In the present invention, the pixels of artifacts 28 having undesirable data values are detected. In the example illustrated, this can be achieved by a specified limiting value which is fallen short of by the shadow-like image of the screws. The detected pixels are grouped into image zones 30 (FIG. 4) and temporarily stored for subsequent use.

The image zones 30 are then filled in by suitable filling operations such that corrected two-dimensional image data (FIG. 5) are produced. The production of corrected image data is carried out for all of the two-dimensional images created from the different directions of projection. The cross-sectional image of the object (FIG. 6) is then produced from the large number of resulting corrected image data, preferably by back projection.

A cross-sectional image of the artifact can be produced in the same manner from the temporarily stored two-dimensional data of the artifacts 28 created from different directions of projection. This can then in turn be combined with the cross-sectional image of the object (FIG. 6) so that the desired cross-sectional image (FIG. 8) is formed, in which the position of the artifact 28 is exactly defined and its environment is depicted in a defined manner. Such an image can provide, for example, considerably better information concerning the healing process than a computed tomography cross-sectional image (FIG. 9) which has not been processed by the method of the invention.

1. A method of producing a cross-sectional image comprising two-dimensional data of an object including an artifact, said method comprising the steps of:
production of two-dimensional image data of the object from different directions of projection,
detection of pixels having an undesirable data value as caused by the artifact,
grouping of said undesirable pixels into image zones,
correction of the image zones by filling operations to produce corrected image data, and
creation of the cross-sectional image of the object from the corrected image data.

2. The method as defined in claim 1, wherein the undesirable data values exceed or fall short of a limiting value or lie within a limiting range.

3. The method as defined in claim 1, wherein the filling operations used for correcting the image zones are at least one of image filling algorithms, morphological image closing procedures and a smoothing procedure.

4. The method as defined in claim 1, wherein a cross-sectional image of the artifact is produced on the basis of said undesirable pixels and the cross-sectional image of the artifact is combined with the cross-sectional image of the object.

5. The method as defined in claim 1, wherein at least one of the cross-sectional image of the object and the cross-sectional image of the artifact is produced by at least one of filtered back projection and by an algebraic reconstruction technology.

6. The method as defined in claim 1, wherein the two-dimensional image data are produced by a conical beam emitter.

7. The method as defined in claim 1, said method being used for medical applications.

8. The method as defined in claim 1, said method being used for producing a computed tomography cross-sectional image.

9. The method as defined in claim 6, wherein the two-dimensional image data are produced by a device which produces a conical beam of X-rays and has a C-shaped arm.
